(19) United States
(12) Patent Application Publication
(10) Pub. No.: US 2014/0003472 A1
(43) Pub. Date: Jan. 2, 2014

(54) DIGITAL FREQUENCY DEMODULATOR WITH LOW POWER CONSUMPTION AND RELATED SYSTEM AND METHOD

(71) Applicant: Darrell Lee Ash, Sachse, TX (US)

(72) Inventor: Darrell Lee Ash, Sachse, TX (US)

(73) Assignee: RF Monolithics, Inc., Dallas, TX (US)

(21) Appl. No.: 13/536,835

(22) Filed: Jun. 28, 2012

(51) Int. Cl. H04L 27/06; H04B 3/36; H04B 1/38

(52) U.S. Cl. 375/211; 375/340; 375/219

(57) ABSTRACT

An apparatus includes a frequency counter configured to receive an input signal containing pulses and to output a count value identifying a number of pulses in the input signal during a specified time period. The specified time period encompasses multiple cycles of the input signal. The apparatus also includes a comparator configured to receive the count value, compare the count value to a second value, and provide an output signal based on the comparison. The apparatus further includes a data latch configured to latch the output signal, where the latched value of the output signal represents a demodulated data value. The comparator could be configured to compare the count value to a fixed value associated with a desired frequency of the input signal. The comparator could also be configured to compare the count value in one specified time period to a stored count value from another specified time period.

### TECHNICAL FIELD

This disclosure is generally directed to frequency demodulators. More specifically, this disclosure relates to a digital frequency demodulator with low power consumption and a related system and method.

### BACKGROUND

Wireless transceivers are routinely being incorporated into smaller and smaller devices. In these types of devices, size and power usage are often important factors in the design of a wireless transceiver. Unfortunately, conventional frequency demodulators in these transceivers are often intolerant to frequency deviations in an incoming signal. Also, conventional frequency demodulators often require large external components, such as external discriminator tank circuits. In addition, conventional frequency demodulators often require the use of quadrature intermediate frequency (IF) paths. Both the external components and the quadrature paths can increase the size, complexity, and cost of the demodulators.

### SUMMARY

This disclosure provides a digital frequency demodulator with low power consumption and a related system and method.

In a first embodiment, an apparatus includes a frequency counter configured to receive an input signal containing pulses and to output a count value identifying a number of pulses in the input signal during a specified time period. The specified time period encompasses multiple cycles of the input signal. The apparatus also includes a comparator configured to receive the count value from the frequency counter, compare the count value to a second value, and provide an output signal based on the comparison. The apparatus further includes a data latch configured to latch the output signal, where the latched value of the output signal represents a demodulated data value.

In a second embodiment, a system includes a receive path configured to process an incoming wireless signal and generate demodulated data, where the receive path includes a digital frequency demodulator. The digital frequency demodulator includes a frequency counter configured to receive an input signal containing pulses and to output a count value identifying a number of pulses in the input signal during a specified time period. The specified time period encompasses multiple cycles of the input signal. The digital frequency demodulator also includes a comparator configured to receive the count value from the frequency counter, compare the count value to a second value, and provide an output signal based on the comparison. The digital frequency demodulator further includes a data latch configured to latch the output signal, where the latched value of the output signal represents a demodulated data value.

In a third embodiment, a method includes receiving an input signal containing pulses and generating a count value identifying a number of pulses in the input signal during a specified time period. The specified time period encompasses multiple cycles of the input signal. The method also includes comparing the count value to a second value and providing an output signal based on the comparison. The method further includes latching the output signal, where the latched value of the output signal represents a demodulated data value.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example transceiver containing a digital frequency demodulator according to this disclosure;

FIGS. 2 and 3 illustrate example digital frequency demodulators according to this disclosure;

FIG. 4 illustrates a more detailed example transceiver containing a digital frequency demodulator according to this disclosure;

FIG. 5 illustrates an example medical implant containing a digital frequency demodulator according to this disclosure; and

FIG. 6 illustrates an example method for using a digital frequency demodulator according to this disclosure.

### DETAILED DESCRIPTION

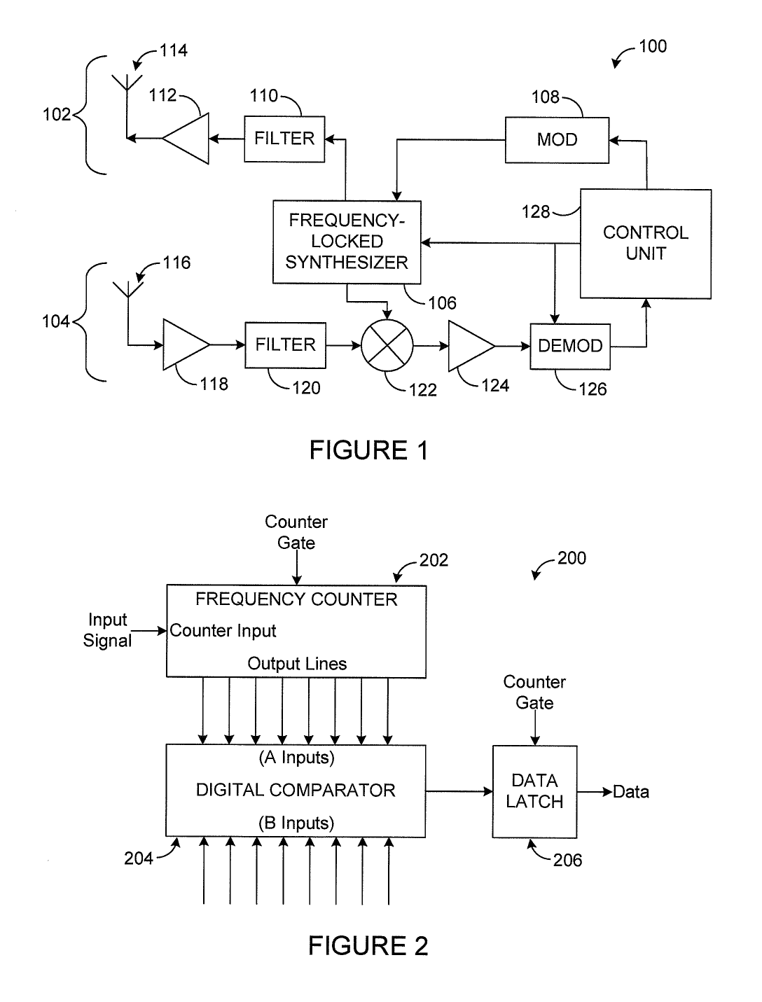

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example transceiver 100 containing a digital frequency demodulator according to this disclosure. As shown in FIG. 1, the transceiver 100 includes a transmit path 102 and a receive path 104. The transmit path 102 converts data to be transmitted into a radio frequency (RF) or other signal suitable for wireless transmission, and the receive path 104 processes an RF or other signal received wirelessly.

A frequency-locked synthesizer 106 provides signals to one or both of the transmit and receive paths 102-104. The transmit path 102 can use the synthesizer 106 to generate signals for wireless transmission. The receive path 104 can use the synthesizer 106 to down-convert signals received wirelessly. The frequency-locked synthesizer 106 includes any suitable structure for generating signals at a desired frequency or within a desired frequency range. In particular embodiments, the frequency-locked synthesizer 106 can be implemented as disclosed in U.S. patent application Ser. No. 13/372,321, which is hereby incorporated by reference. Note that the output of a single synthesizer 106 could be provided to both the transmit and receive paths 102-104, or separate synthesizers 106 could be used for the transmit and receive paths 102-104.

The transmit path 102 in this example includes a modulator 108, which modulates data to be transmitted. The modulator 108 can use any suitable modulation technique to modulate the data. In this example, the modulator 108 modulates the output of the synthesizer 106, and the synthesizer's output is used directly as the outgoing signal. For example, the modulator 108 could use on/off keying (OOK) modulation to turn an amplifier in the frequency-locked synthesizer 106 on and off. The modulator 108 could also use frequency shift keying (FSK) modulation, such as by controlling the operation of a discriminator in the frequency-locked synthesizer 106 (like altering the width of pulses in a gating signal provided to the discriminator). The modulated output of the synthesizer 106 is filtered by a filter 110 and amplified by an amplifier 112, such as a low-power amplifier. The amplified signal is transmitted as an outgoing wireless signal through an antenna 114.

The receive path 104 in this example includes an antenna 116, which receives an incoming wireless signal. An amplifier 118 amplifies the received signal, and a filter 120 filters the amplified signal. The filtered signal is down-converted by a mixer 122, which mixes the filtered signal with a lower-frequency signal from the synthesizer 106. The down-converted signal is amplified by a limiting amplifier 124, and a demodulator 126 demodulates data contained in the down-converted, amplified, and limited signal.

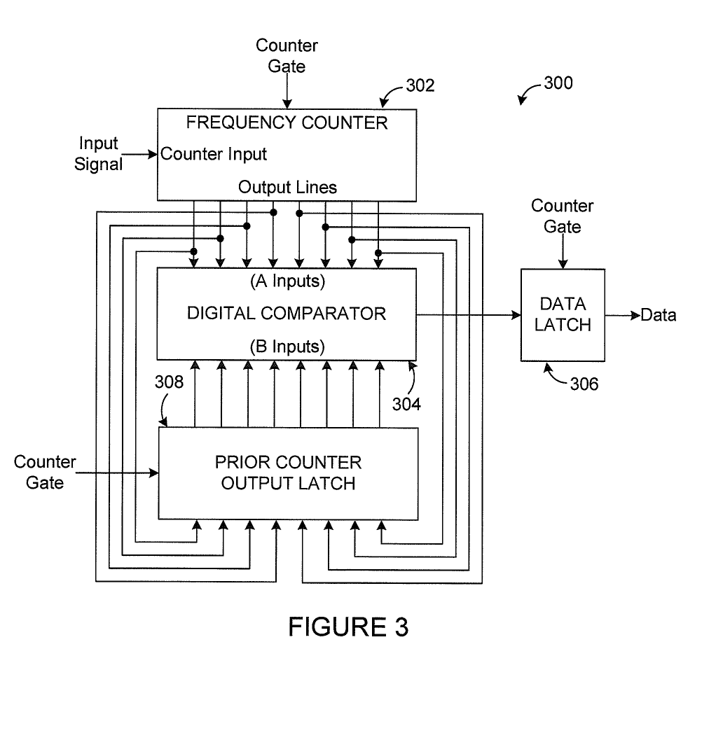

The modulator 108 includes any suitable structure for modulating data. The demodulator 126 includes a digital frequency demodulator, such as one shown in FIGS. 2 and 3 described below. Each filter 110, 120 includes any suitable structure for filtering a signal, such as a low-pass or band-pass filter. Each amplifier 112, 118 includes any suitable structure for amplifying a signal. The mixer 122 includes any suitable structure for mixing signals. The limiting amplifier 124 includes any suitable structure for amplifying a signal and limiting its output. Each antenna 114, 116 includes any suitable structure for transmitting or receiving a wireless signal. In some embodiments, the transmit and receive paths 102-104 support the use of RF communications, although other suitable wireless signals could be used.

In this example, a control unit 128 is coupled to the transmit and receive paths 102-104. The control unit 128 performs any of a wide variety of functions in the transceiver 100. For example, the control unit 128 can generate or receive data to be transmitted wirelessly and provide that data to the transmit path 102. The control unit 128 can also obtain data received wirelessly from the demodulator 126 and provide that data to one or more external devices or systems. The control unit 128 can further interact with and control the frequency-locked synthesizer 106, the demodulator 126, or other components, such as by providing one or more gating signals to the frequency-locked synthesizer 106 and the demodulator 126. The control unit 128 includes any suitable structure for controlling a transceiver. For instance, the control unit 128 could include at least one microprocessor, microcontroller, digital signal processor (DSP), field programmable gate array (FPGA), application specific integrated circuit (ASIC), or other processing or control device.

Although FIG. 1 illustrates one example of a transceiver 100 containing a digital frequency demodulator, various changes may be made to FIG. 1. For example, other implementations of the transmit and receive paths 102-104 could be used. As a particular example, while the transmit and receive paths 102-104 are shown as having their own antennas 114-116, the paths 102-104 could share a common antenna. Also, various components in FIG. 1 could be combined, further subdivided, or omitted and additional components could be added according to particular needs. For instance, the transmit path 102 could be omitted in a receive-only device. As another example, the functionality of the modulator 108 could be incorporated into the synthesizer 106. As yet another example, an IF filter could be inserted between the mixer 122 and the limiting amplifier 124. In addition, FIG. 1 illustrates one example of an operational environment where a digital frequency demodulator could be used. Digital frequency demodulators could be used in any other suitable device or system.

FIGS. 2 and 3 illustrate example digital frequency demodulators according to this disclosure. As shown in FIG. 2, a digital frequency demodulator 200 includes a frequency counter 202, a digital comparator 204, and a latch 206.

The frequency counter 202 receives an input signal, such as an intermediate frequency (IF) signal in a transceiver. In the transceiver 100 shown in FIG. 1, the frequency counter 202 could receive an IF signal from the limiting amplifier 124, although the frequency counter 202 could receive an IF signal from other components. The frequency counter 202 counts the number of pulses in the input signal during a specified time period, where the specified time period is defined by a counter gate signal. The frequency counter 202 includes any suitable structure for counting pulses in a signal during a specified time period, such as an eight-bit counter. The counter gate signal could have any suitable period, such as a fixed period that may be synchronous or asynchronous with the data in the input signal. The counter gate signal could also be provided by any suitable source, such as the control unit 128.

In some embodiments, the length of the counter gate period allows sampling of the incoming input signal multiple times per data bit, such as two or more samples per bit. Also, the length of the counter gate period could be defined so that multiple cycles of the input signal are counted and accumulated, possibly a large number of cycles (an example would be 200 cycles of an IF signal).

A count value from the frequency counter 202 is provided to the digital comparator 204. The digital comparator 204 compares the count value provided by the frequency counter 202 (A input) to a fixed value (B input). The fixed value represents the count value that would be obtained during the specified time period if the input signal has a desired frequency, such as if the input signal is at a specified center frequency. The digital comparator 204 outputs a value depending on whether the count value provided by the frequency counter 202 is greater than or less than the fixed value. For example, the output of the digital comparator 204 could be a logical high value if the A input is greater than the B input and a logical low value if the A input is less than the B input. The digital comparator 204 includes any suitable structure for comparing digital input values, such as an eight-bit comparator. In this example, the digital comparator 204 is configured to receive and compare parallel input values. The fixed value could be provided as the B input by any suitable source, such as the control unit 128, a dedicated register, or other source.

At the end of each counter gate period, the frequency counter 202 is reset in order to take another sample of the input signal. The latch 206 is used to store the output of the digital comparator 204 at the end of each counter gate period. The latch 206 includes any suitable structure for storing a data value, such as a D flip-flop. The latch 206 stores a data value until the end of the next counter gate period when another sample is latched.

The output of the latch 206 represents demodulated data. As an example, an IF input signal could be a 10 MHz signal with a ±100 kHz frequency deviation at a data rate of 10 kbps. The counter's gate period could be 20 μs with a 1 μs reset time between gates. The counter 202 and the digital comparator 204 could be eight-bit devices, and the B input to the comparator 204 could be a value of 11001000 (a decimal value of 200). The counter 202 would output a count value of 200 if the input signal is at 10 MHz, a count value of 202 if the input signal is at 10.1 MHz, and a count value of 198 if the input signal is at 9.9 MHz. Thus, the digital comparator 204 could output a high logical value at 10.1 MHz and a low logical value at 9.9 MHz. The counter gate repetition rate allows making a frequency determination approximately five times per bit for the 10 kbps data rate (100 μs bit time).

As shown in FIG. 3, a digital frequency demodulator 300 includes a frequency counter 302, a digital comparator 304, and a latch 306. These components could be the same as or similar to the corresponding components shown in FIG. 2.

In FIG. 3, the B input to the digital comparator 304 is provided by a prior counter output latch 308. The latch 308 stores the value previously output by the counter 302 during a prior counter gate period, such as the immediately preceding counter gate period. As a result, the output of the digital comparator 304 indicates whether the current count value provided by the counter 302 is greater than or less than the prior count value provided by the counter 302. The prior counter output latch 308 includes any suitable structure for storing a counter value, such as a collection of D flip-flops.

Again, the output of the latch 306 represents demodulated data. In this case, however, rather than looking for pulse counts above or below an expected value, the demodulator 300 looks for pulse count changes from one gate period to the next. The demodulator 300 could still operate with an IF input signal at 10 MHz with a data rate of 10 kbps, and the counter's gate period could be 20 μs with a 1 μs reset time between gates. The counter gate repetition rate again allows making a frequency determination approximately five times per bit for the 10 kbps data rate (100 μs bit time).

In the embodiments shown in FIGS. 2 and 3, the power consumption of the demodulators 200, 300 can be quite low, such as when the maximum rate seen by the counters 202, 302 is around 10 MHz. Moreover, the demodulators 200, 300 may allow for frequency errors of at least ±50 kHz, making them more tolerant to frequency deviations in the input signals. In addition, the architectures of the demodulators 200, 300 require no quadrature paths or large external discriminator tank circuits. Overall, the demodulators 200, 300 can have a smaller size, simpler complexity, and lower cost compared to various conventional frequency demodulators.

Although FIGS. 2 and 3 illustrate examples of digital frequency demodulators 200 and 300, various changes may be made to FIGS. 2 and 3. For example, each component shown in FIGS. 2 and 3 could be implemented using any suitable circuitry that performs the same or similar function.

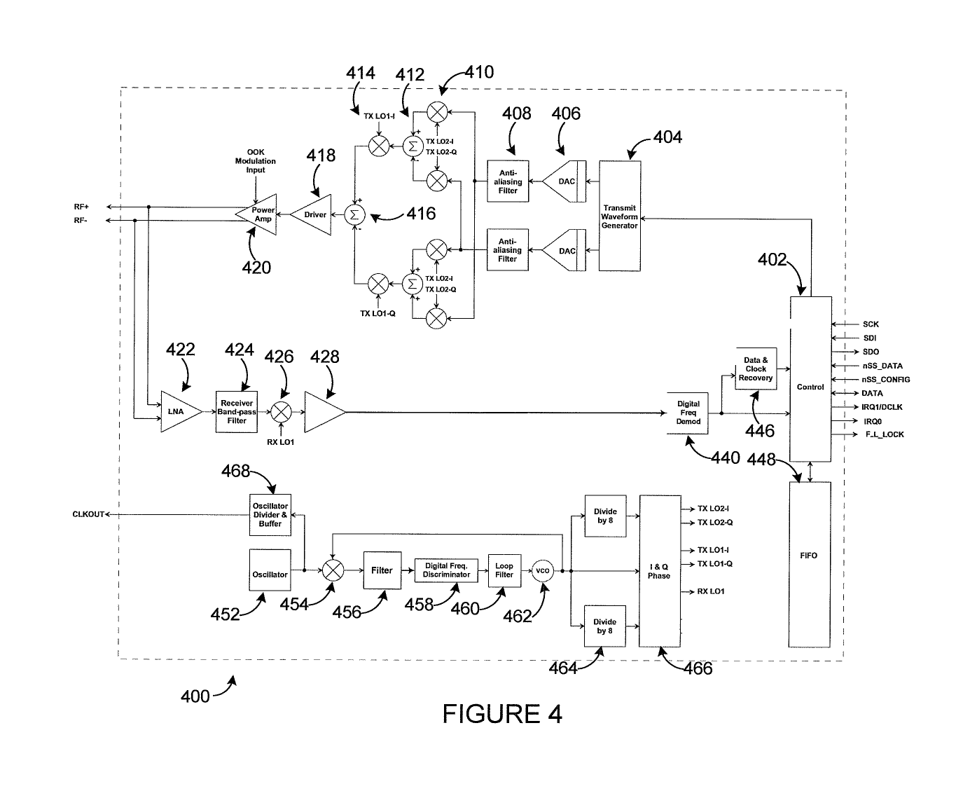

FIG. 4 illustrates a more detailed example transceiver 400 containing a digital frequency demodulator according to this disclosure. As shown in FIG. 4, the transceiver 400 includes a control unit 402, which controls the overall operation of the transceiver 400. The control unit 402 can be coupled to various input/output signal lines, such as serial communication lines.

A transmit path in the transceiver 400 includes a transmit waveform generator 404, which generates digital transmit waveforms using data to be transmitted. The transmit waveform generator 404 could also support a modulation scheme, such as FSK modulation. The waveforms are provided to two digital-to-analog converters 406, which convert the digital waveforms into analog signals. The analog signals are filtered using two anti-aliasing filters 408. Four mixers 410 mix the filtered signals with various local oscillator (LO) signals, and two combiners 412 combine the outputs of the mixers 410. Two additional mixers 414 mix the outputs of the combiners 412 with additional LO signals, and a combiner 416 combines the outputs of the mixers 414. A driver 418 drives a power amplifier 420 using the output of the combiner 416. The power amplifier 420 can also support the use of OOK modulation.

A receive path in the transceiver 400 includes a low-noise amplifier (LNA) 422, which amplifies an incoming signal. A filter 424, such as a band-pass filter, filters the amplified signal. A mixer 426 mixes the amplified signal with an LO signal. A limiting amplifier 428 amplifies the output of the mixer 426 while limiting its output. The output of the amplifier 428 is provided to a digital frequency demodulator 440, which demodulates FSK-modulated data. The digital frequency demodulator 440 could represent one of the digital frequency demodulators 200, 300 described above. The output of the digital frequency demodulator 440 is provided to the control unit 402 and to a data and clock recovery unit 446, which recovers clock and data from the incoming signal.

A memory 448 is coupled to the control unit 402. The memory 448 stores any suitable data for use by the control unit 402. The memory 448 includes any suitable structure for storing and facilitating retrieval of data. In this example, the memory 448 represents a first-in, first-out (FIFO) queue.

In this example, a frequency-locked synthesizer is used in the transceiver 400 to help generate the various LO signals used by the mixers 410, 414, 426. As shown in FIG. 4, the frequency-locked synthesizer includes an oscillator 452, a frequency difference detector 454, a filter 456, a digital frequency discriminator 458, a loop filter 460, and a voltage-controlled oscillator (VCO) 462. The output of the VCO 462 is provided to two “divide by 8” dividers 464 and to an LO unit 466. The LO unit 466 uses the outputs of the VCO 462 and the dividers 464 to generate the LO signals for use in the transmit and receive paths. The output of the oscillator 452 is also provided to a divider and buffer unit 468, which can lower the frequency of the oscillator's output and provide the resulting signal to components outside of the transceiver 400. Although not shown, outputs from the oscillator 452, loop filter 460, and VCO 462 could also be provided directly to components outside of the transceiver 400, such as through various input-output pins.

Each component shown in FIG. 4 could be implemented using any suitable circuitry that performs the described function(s). In some embodiments, all of the components shown in FIG. 4 are implemented within a single integrated circuit chip.

Although FIG. 4 illustrates one example of a more detailed transceiver 400 containing a digital frequency demodulator, various changes may be made to FIG. 4. For example, other implementations of the transmit and receive paths could be used. Also, other modulation techniques could be supported by the transceiver 400. In addition, various components in FIG. 4 could be combined, further subdivided, or omitted and additional components can be added according to particular needs. As an example, an IF filter could be inserted between the mixer 426 and the limiting amplifier 428.

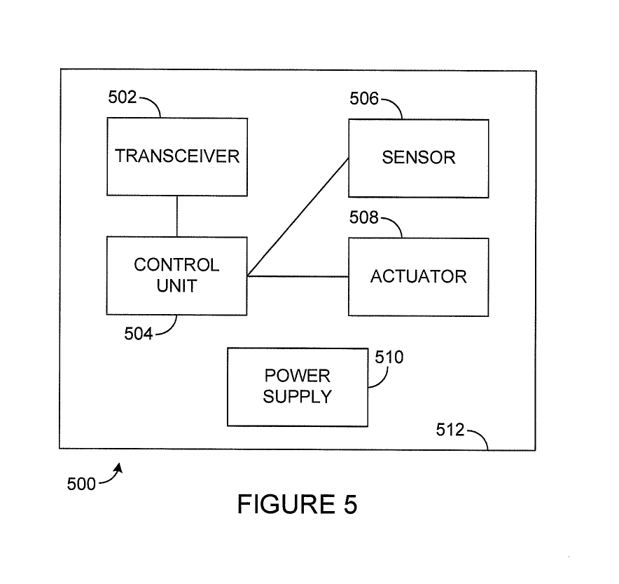

FIG. 5 illustrates an example medical implant 500 containing a digital frequency demodulator according to this disclosure. As shown in FIG. 5, the medical implant 500 includes a transceiver 502 and a control unit 504. The transceiver 502 could represent the transceiver 100 shown in FIG. 1 or the transceiver 400 shown in FIG. 4. However, the transceiver 502 could be replaced by a stand-alone transmitter, a stand-alone receiver, or both. The transceiver 502 also includes a digital frequency demodulator, such as the digital frequency demodulator 200 or 300 shown in FIGS. 2 and 3.

The control unit 504 controls the overall operation of the implant 500. For example, the control unit 504 could receive measurement data from one or more sensors 506, and the control unit 504 could provide the measurement data to the transceiver 502 for communication. The control unit 504 could also process the data and provide processing results to the transceiver 502 for communication. The control unit 504 could further receive control signals received wirelessly by the transceiver 502, and the control unit 504 could use the signals to adjust operation of one or more actuators 508. The control unit 504 includes any suitable structure for controlling the implant 500. For instance, the control unit 504 could include at least one microprocessor, microcontroller, DSP, FPGA, ASIC, or other processing or control device.

Each sensor 506 represents any suitable mechanism for detecting or measuring one or more characteristics of the implant 500 itself or the environment surrounding the implant 500. The specific sensing operation(s) performed by the sensor(s) 506 could vary depending on the specific use of the implant 500. Each actuator 508 represents any suitable mechanism for performing one or more functions for or within a patient. The specific operation(s) performed by the actuator(s) 508 could vary depending on the specific use of the implant 500.

A power supply 510 provides operating power to various components of the implant 500. The power supply 510 includes any suitable source of power. For instance, in some embodiments, the power supply 510 represents at least one battery that provides intermittent, near continuous, or continuous power to other components of the implant 500. In other embodiments, the power supply 510 collects power from an external source, such as by inductively receiving power from a device near the implant 500. In still other embodiments, the power supply 510 represents a power source that generates power from the surrounding environment, such as by using a piezo-electric power scavenging device.

A housing 512 houses or encases the various other components of the implant 500. The housing 512 can have any suitable shape depending on, for instance, the location of intended implantation for the implant 500. The housing 512 can also be formed from any suitable material(s), such as a biologically suitable material like a polymer or a metal.

Although FIG. 5 illustrates one example of a medical implant 500 containing a digital frequency demodulator, various changes may be made to FIG. 5. For example, FIG. 5 illustrates a generic implant meant to represent a wide range of potential implantable medical devices that could use a digital frequency demodulator. Any suitable implantable medical device using a wireless transceiver or receiver could use a digital frequency demodulator such as the one described above.

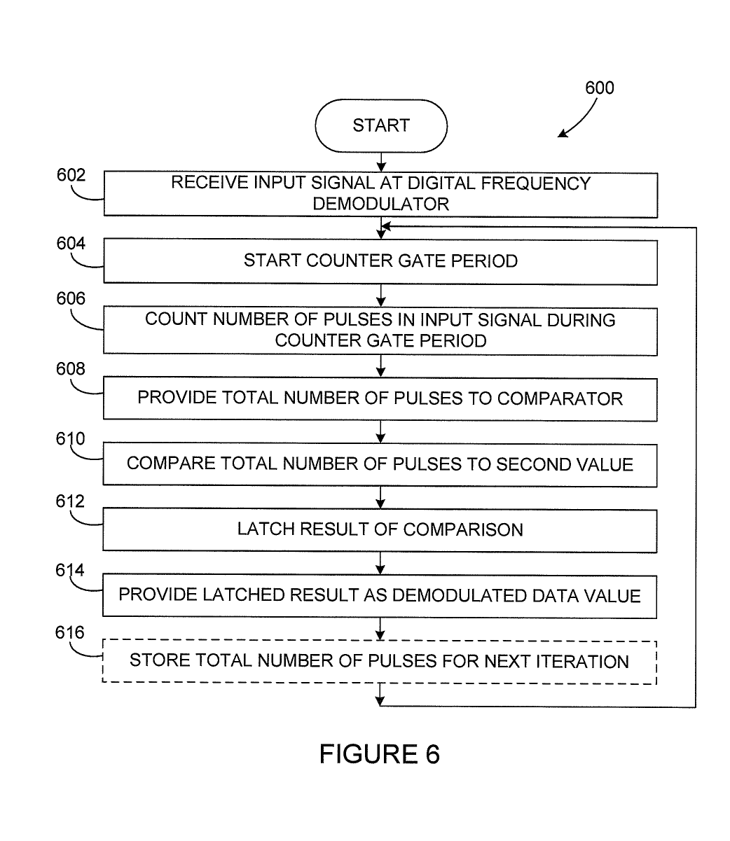

FIG. 6 illustrates an example method 600 for using a digital frequency demodulator according to this disclosure. As shown in FIG. 6, an input signal is received at a digital frequency demodulator at step 602. This could include, for example, receiving an IF input signal from the limiting amplifier 124 or 428.

A counter gate period begins at step 604. This could include, for example, the control unit 128 or 402 providing a pulse in the counter gate signal to the frequency counter, data latch, and optionally the prior counter output latch in the digital frequency demodulator. The number of pulses in the input signal is counted during the counter gate period at step 606. This could include, for example, the frequency counter in the digital frequency demodulator counting the number of pulses in the input signal.

The total number of pulses during the counter gate period is provided to a digital comparator at step 608. This could include, for example, the frequency counter providing the total count value in parallel format to the digital comparator in the digital frequency demodulator. The total number of pulses is compared to a second value at step 610. This could include, for example, the digital comparator in the digital frequency demodulator comparing the total number of pulses to a fixed value or a previous count value. The comparator could receive the fixed value or previous count value in parallel format. The result of the comparison is latched at step 612, and the latched output is provided as a demodulated data value at step 614. This could include, for example, latching the output of the digital comparator in a data latch.

Optionally, the total number of pulses is stored for the next iteration of the method at step 616. This could include, for example, storing the total number of pulses in the prior counter output latch of the digital frequency demodulator. The latched value could then be used at step 610 during the next iteration of the method 600. However, if the second value used in step 610 is a fixed value or other value, step 616 could be omitted.

Although FIG. 6 illustrates one example of a method 600 for using a digital frequency demodulator, various changes may be made to FIG. 6. For example, while shown as a series of steps, various steps in FIG. 6 could overlap, occur in parallel, occur in a different order, or occur any number of times. As a particular example, steps 604-614 or 604-616 could repeat during any number of iterations.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with” and its derivatives mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a frequency counter configured to receive an input signal containing pulses and to output a count value identifying a number of pulses in the input signal during a specified time period, the specified time period encompassing multiple cycles of the input signal;
a comparator configured to receive the count value from the frequency counter, compare the count value to a second value, and provide an output signal based on the comparison; and
a data latch configured to latch the output signal, wherein the latched value of the output signal represents a demodulated data value.

2. The apparatus of claim 1, wherein the comparator is configured to compare the count value to a fixed value, the fixed value associated with a desired frequency of the input signal.

3. The apparatus of claim 1, wherein the frequency counter is configured to output multiple count values during multiple specified time periods.

4. The apparatus of claim 3, wherein:
the apparatus further comprises a prior counter output latch configured to store the count value generated during one of the specified time periods; and
the comparator is configured to compare the count value in another of the specified time periods to the stored count value.

5. The apparatus of claim 3, wherein the frequency counter and the data latch are configured to receive a counter gate signal defining the specified time periods.

6. The apparatus of claim 1, wherein:
the frequency counter is configured to output the count value in parallel format; and
the comparator is configured to receive the count value in parallel format and the second value in parallel format.

7. The apparatus of claim 1, wherein the data latch comprises a D flip-flop.

8. A system comprising:
a receive path configured to process an incoming wireless signal and generate demodulated data, the receive path comprising a digital frequency demodulator;
wherein the digital frequency demodulator comprises:
a frequency counter configured to receive an input signal containing pulses and to output a count value identifying a number of pulses in the input signal during a specified time period, the specified time period encompassing multiple cycles of the input signal;
a comparator configured to receive the count value from the frequency counter, compare the count value to a second value, and provide an output signal based on the comparison; and
a data latch configured to latch the output signal, wherein the latched value of the output signal represents a demodulated data value.

9. The system of claim 8, wherein the receive path is configured to generate an intermediate frequency signal using the incoming wireless signal, the input signal to the frequency counter comprising the intermediate frequency signal.

10. The system of claim 8, wherein the comparator is configured to compare the count value to a fixed value, the fixed value associated with a desired frequency of the input signal.

11. The system of claim 8, wherein the frequency counter is configured to output multiple count values during multiple specified time periods.

12. The system of claim 11, wherein:
the digital frequency demodulator further comprises a prior counter output latch configured to store the count value generated during one of the specified time periods; and
the comparator is configured to compare the count value in another of the specified time periods to the stored count value.

13. The system of claim 11, wherein the frequency counter and the data latch are configured to receive a counter gate signal defining the specified time periods.

14. The system of claim 8, wherein:
the frequency counter is configured to output the count value in parallel format; and
the comparator is configured to receive the count value in parallel format and the second value in parallel format.

15. The system of claim 8, wherein the receive path further comprises:
a first amplifier configured to amplify the incoming wireless signal;
a filter configured to filter the amplified wireless signal;
a mixer configured to down-convert the filtered wireless signal; and
a second amplifier configured to amplify the down-converted signal, the second amplifier having an output coupled to an input of the frequency counter.

16. The system of claim 8, further comprising:
a transceiver including the receive path;
a sensor configured to sense at least one characteristic of a patient;
an actuator configured to modify the at least one characteristic of the patient; and
a control unit configured to control the actuator.

17. A method comprising:
receiving an input signal containing pulses;
generating a count value identifying a number of pulses in the input signal during a specified time period, the specified time period encompassing multiple cycles of the input signal;
comparing the count value to a second value;
providing an output signal based on the comparison; and
latching the output signal, wherein the latched value of the output signal represents a demodulated data value.

18. The method of claim 17, wherein comparing the count value comprises comparing the count value to a fixed value, the fixed value associated with a desired frequency of the input signal.

19. The method of claim 17, wherein:
generating the count value, comparing the count value, providing the output signal, and latching the output signal are repeated during multiple specified time periods;
the method further comprises storing the count value generated during one of the specified time periods; and
comparing the count value comprises comparing the count value in another of the specified time periods to the stored count value.

20. The method of claim 17, further comprising:
generating an intermediate frequency signal using an incoming wireless signal, the input signal comprising the intermediate frequency signal.
